(19) United States
(12) Patent Application Publication
(10) Pub. No.: US 2020/0401994 A1
(43) Pub. Date: Dec. 24, 2020

(54) PACKING AND SHIPMENT SHARING THROUGH TRUSTED NETWORK

(71) Applicant: International Business Machines Corporation, Armonk, NY (US)

(72) Inventors: Uri Kartoun, Cambridge, MA (US); Yoonyoung Park, Cambridge, MA (US); Vibha Anand, Cambridge, MA (US); Fang Lu, Billerica, MA (US)

(21) Appl. No.: 16/448,325

(22) Filed: Jun. 21, 2019

(51) Int. Cl. G06Q 10/08; G06Q 30/06; G06F 16/9035; G06F 16/909; G06Q 30/02

(52) U.S. Cl. CPC G06Q 10/0832; G06Q 30/0635; G06Q 30/0222; G06F 16/9035; G06F 16/909; G06Q 10/08355

(57) ABSTRACT

A shipment sharing method, system, and computer program product include collecting a shopping order history, neighborhood information and friends' information from user data, analyzing a current order by a user from a shopping service, checking whether a neighbor identified from the neighborhood information and the friend information purchased an item from the shopping service based on the shopping order history, and suggesting to the user to share a packing and shipment cost with the neighbor by combining the purchased one or more items by the neighbor and the current order by the user in a single package.

### BACKGROUND

The present invention relates generally to a shipment sharing method, and more particularly, but not by way of limitation, to a system, method, and computer program product for allowing consumers who reside closely to one another to union items in a shared packaging box.

Typically, a company with shipments will ship orders to each user individually regardless of whether another item is being shipped to nearby neighbours or friends. That is, each person receives individually a packaged shipment for his/her order.

Conventional techniques to improve shipments consider improvements to the community shipping challenges. One conventional technique provides community-based shipping of items that may provide mechanisms that allow customers of a network service to participate in a community shipping program that provides customers that are members in a community with free (or reduced-rate) shipping. Such free or reduced-rate shipping is for at least some items ordered via the network service for delivery to a target location (e.g., receiving/distribution site) for the community.

However, the conventional techniques do not consider the dimensions, quantity and, the characters of the purchased items from each user to determine what are the optimal combinations of these items in order to provide a combined shipment to share the cost between the two (or more) purchasers.

### SUMMARY

In an exemplary embodiment, the present invention provides a computer-implemented shipment sharing method, the method includes collecting a shopping order history, neighborhood information and friend information from user data, analyzing a current order by a user from a shopping service, checking whether a neighbor identified from the neighborhood information and the friend information purchased an item from the shopping service based on the shopping order history, and making a suggestion to the user to share a packing and shipment cost with the neighbor by combining the purchased item by the neighbor and the current order by the user in a single package. In one embodiment, the shipping cost is split between two or more users thus reducing the shipping cost if each had to pay for shipping individually. In another embodiment, other incentives are proposed to the users, such as a discount for the purchased items or a faster arrival.

One or more other exemplary embodiments include a computer program product and a system, based on the method described above.

Other details and embodiments of the invention are described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a shipment sharing method 100 according to an embodiment of the present invention;

FIG. 2 exemplarily depicts an example flow of shipment sharing according to an embodiment of the present invention;

FIG. 3 depicts a cloud-computing node 10 according to an embodiment of the present invention;

FIG. 4 depicts a cloud-computing environment 50 according to an embodiment of the present invention; and

FIG. 5 depicts abstraction model layers according to an embodiment of the present invention.

### DETAILED DESCRIPTION

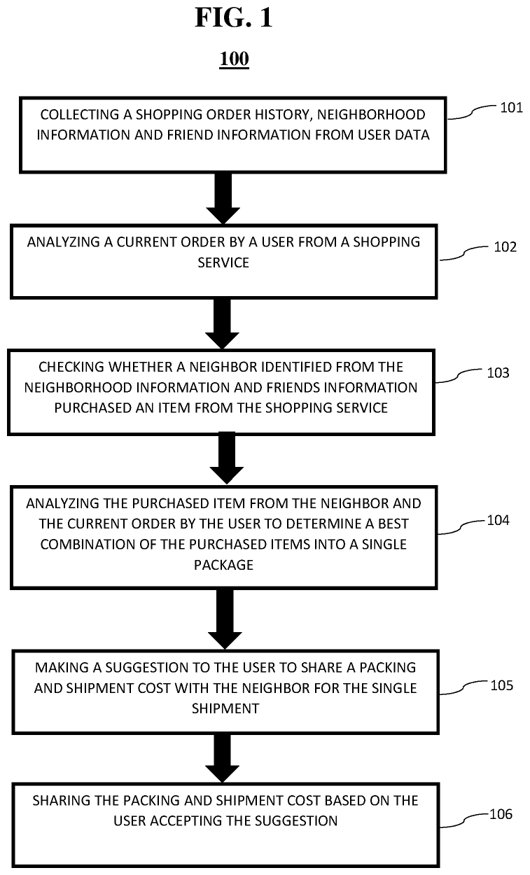

The invention will now be described with reference to FIGS. 1-5, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a shipment sharing method 100 according to the present invention can include various steps to allow consumers who reside closely to one another to union (i.e., aggregate, unite, combine, etc.) items in a shared packaging box, to make recommendations to users to share packing and shipping costs for their purchased items, and to match neighbors that have similar purchasing habits based on users' historical orders such that the invention may greatly lower shipping and packing costs for many products purchased and shipped.

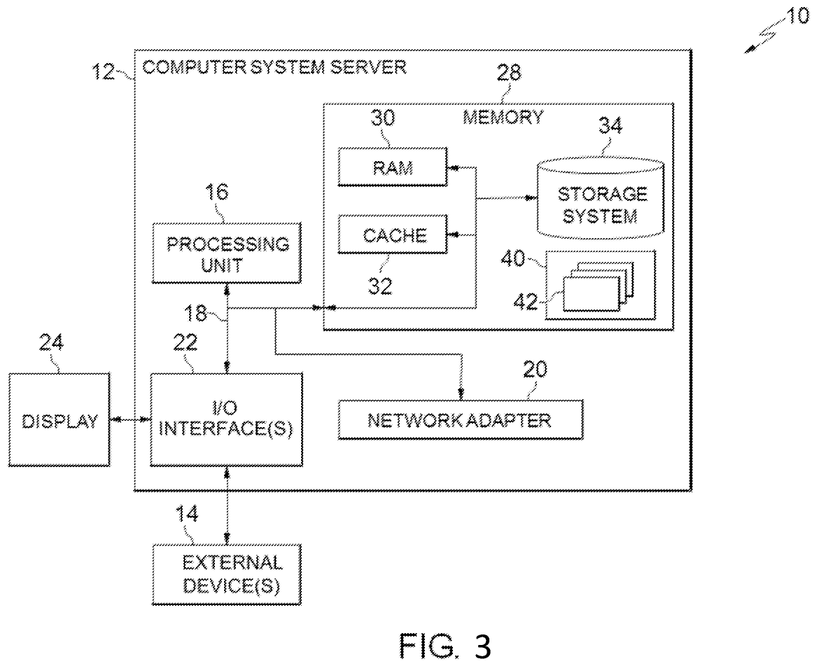

By way of introduction of the example depicted in FIG. 3, one or more computers of a computer system 12 according to an embodiment of the present invention can include a memory 28 having instructions stored in a storage system to perform the steps of FIG. 1.

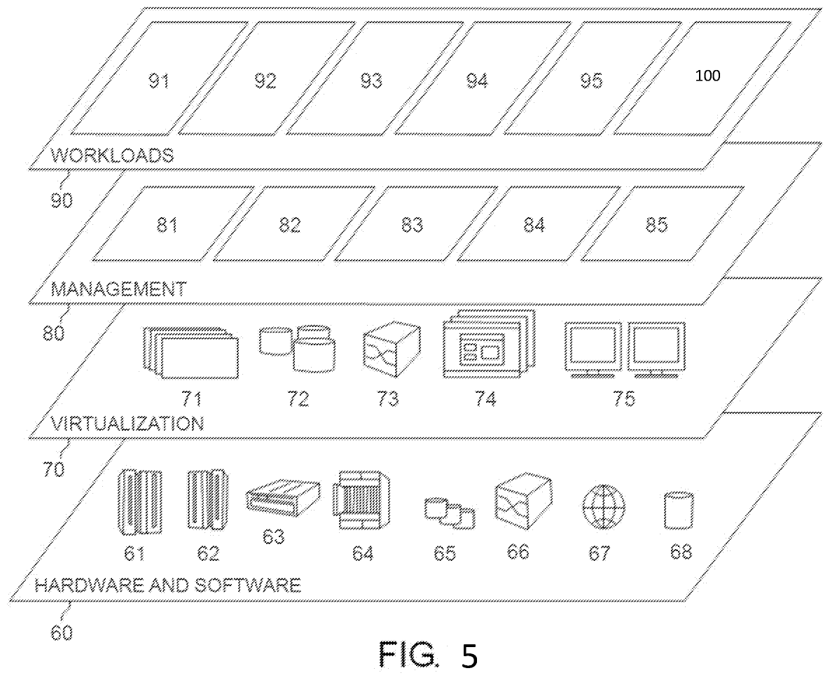

Although one or more embodiments may be implemented in a cloud environment 50 (e.g., FIG. 5), it is nonetheless understood that the present invention can be implemented outside of the cloud environment.

It is noted that “shopping service” can include an online website store, a physical (i.e., “brick and mortar”) store that the user shops at, a subscription service, etc. A shopping service can interface with the invention as long as the user can purchase an item and the item can be shipped to the user. Thereby, the invention can include embodiments for online shopping such as on Amazon® or shopping at a local grocery store that offers a shipment service.

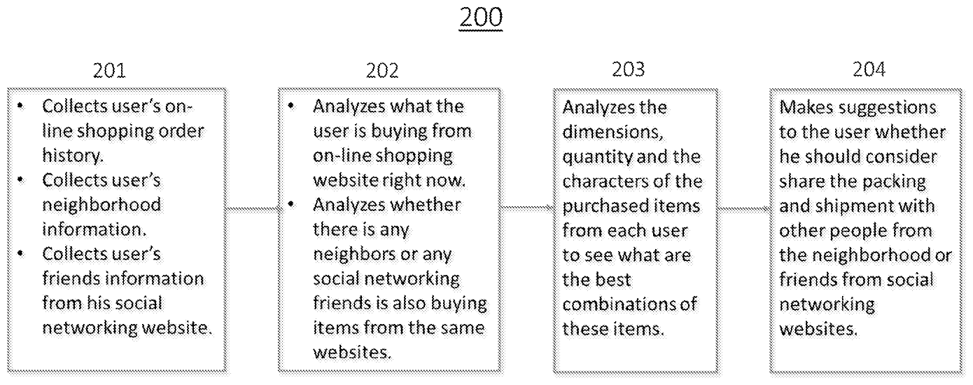

With reference generally to FIGS. 1 and 2, in steps 101 and 201, information regarding shopping order history, neighborhood information and friend information is collected from user data. For example, people can opt-in to the invention and they can be matched with their neighbors. Similarly, a social networking service can be analyzed to determine friends who live in a short proximity to the user. In a more advanced embodiment, real estate records can be analyzed to determine where the user lives and who owns property next to the user. The property ownership can then be correlated with accounts used to purchase items from a shopping service.

In steps 102 and 202, a current order by a user from a shopping service is analyzed. That is, the order is analyzed to track item information such as shipment date, size (i.e., dimensions), weight, fragility, temperature and/or expiration constraints (e.g., groceries), subscription service item, etc.

In step 103, a neighbor (or friend) is identified that purchased an item from the same shopping service (or that uses a same shipping company to ship orders such as DHL®, FEDEX® or UPS®) using the data from step 101. For example, the neighbor can be identified as subscribing to the same subscription service (i.e., water delivery once per month) or purchasing an item from Amazon® at the same time (or with a same shipment date).

In step 104, factors of the purchased item by the neighbor and the current order by the user are analyzed to determine an optimal combination for shipping the purchased one or more items and the current order in a single package. That is, the items are analyzed by considering factors such as weight, size, requested delivery date, subscription date, etc. to provide an optimal combination of items. As noted in step 203, the dimensions, quantity and the characteristics of the purchased items from each user to see what are the optimal combinations of these items. In one embodiment a user, User A, wishes to purchase an item denoted as Item A at an on-line e-commerce website. User A adds Item A to his/her Cart and as a next step planes to pay for the item. In current e-commerce systems the user knows upfront the price of Item A as well as an estimated arrival date (say 5 business days from date of purchasing). The invention is capable or knowing the dimensions of Item A as well as the dimensions of the package required to ship Item A to User A's address. The invention is also capable of determining at time or purchasing whether an envelope or a carton package is necessary and what additional packaging materials might be necessary; for instance, if Item A is fragile then a carton package packed also with large bubble wrap/other absorbing materials must be used, and thus require a larger carton. Before User A performs the actual purchase, the invention can advise him/her on a neighbor, Neighbor A, that is at a high likelihood to purchase several items at the same e-commerce website (Item B and Item C). The invention system suggests both User A and Neighbor A to unify their items in a one package and receive not only free shipping, but also a 2% discount for all their items. The tradeoff will be a delay of one day, so instead of 5 business days, Item A will arrive within 6 days. User A approves Neighbor A as he/she identifies that Neighbor A is a trusted person whom User A knows in person. Neighbor A approves User A as well given their neighborhood has always been friendly. As a result of that all three items are packed in a one box that perfectly fit them, with a dimension smaller in comparison to if 2 packages were about to be sent separately to both User A and Neighbor A.

For example, if the neighbor orders a couch on the same day as the user orders a pillow from the same company, the items can potentially be combined into a same shipment to save shipping costs. But, if the couch requires assembly and may not be shipped for six weeks while the pillow is in stock, it would not be desirable to let the user wait 6 weeks for the pillow. Nonetheless, the invention can prompt the user with the option to combine the orders anyway to save on shipment costs.

In other words, the invention attempts to combine items into a single shipment and then queries the user (and neighbor) to confirm the combination. Multiple options can be presented to the neighbor and the user such as: “If you combine the items you will save $10.00 in shipping but your item will arrive one day later” or “If you combine the items you will save $4.00 in shipping but your item will arrive six weeks later”.

Based on the information provided, the user can select whether they want to opt-in to the service to combine items for shipment.

In steps 105 and 204, a suggestion is made to the user (i.e., such as above) to share packaging and shipment costs with the neighbor for the single shipment. And, in step 106, the packaging and shipment cost is shared if the user accepts the suggestion from step 105.

In this manner, information is provided to the user regarding an amount of money they will save and if the shipment date will change based on combining the items. Therefore, the user can determine if the amount of savings in a cost of the shipment is worth a possible delay.

In one embodiment, for a subscription service, the user can be notified in step 105 that a neighbor has subscribed to the same service and a suggestion can be made to make their subscription delivery date the same to combine the shipment and save money on shipping and handling.

Also, in another embodiment, the size, weight, delay, etc. is considered to apportion the cost to the user and to the neighbor for a shipment. For example, in the above couch and pillowcase, the neighbor ordering the couch may end up paying 95% of the shipment cost because the invention determines that 95% of the cost for shipping and handling is associated with the couch. In this manner, the invention can evenly bill each person receiving a package for their fair share. It is noted that delay can be considered for the “fair share” of the cost. For example, the delaying user can offer an incentive for the other user (neighbor) to combine shipments such that both still save money (i.e., offering a $10 voucher to the user to have a one day delay in their order so that they can combine shipment to each save $15).

In another embodiment, a friend that does not live next to the user can be included in the service (i.e., not a neighbor). Therefore, friends can create a group for which they can share their shipment costs and then arrange pick-up themselves at one of the friend's locations. Thereby, shipping can be split amongst the friends.

In one exemplary use case, John logs on to an on-line shopping website, as he needs to buy one book. John noticed that he needs to pay $3 for the shipment of the book. The invention evaluates which other person from John's neighborhood or from his social media website friends' list (such as Facebook) also buys items from the same website. The invention identifies that John's neighbor Susan is in the process of buying a desk lamp. Susan needs to pay $3 for the shipment. The invention calculates the dimension of John's book and Susan's desk lamp. The invention determines the book and the desk lamp can fit into one shipping box that would only cost $4 for the shipment. The invention suggests to both John and Susan that they can share the packing box and each of them only needs to pay $2 for the shipping box. John and Susan both agree to use the suggested shipping method.

Therefore, the invention may provide the most possible optimal shipping strategy with low cost for interested parties. The invention also benefits the environment by reducing the usage of shipping boxes and having to use potentially multiple transport mechanisms (e.g., truck, planes, rail, etc.) to ship a plurality of boxes instead of just one box having a combination of items therein. Prior techniques only allow people to share shopping carts.

Thus, in one embodiment, the invention is able to access user's past on-line shopping order history, access user's neighborhood information, access friends' list information from the user's social networking websites while being integrated with the on-line shopping website as a service. The invention may detect if the user is in the process of purchasing items from the on-line shopping website and analyzes what type of items that have been added to the shopping cart. The invention evaluates whether anybody in the user's neighborhood or friends from his/her social networking websites are in the process of purchasing items. The invention further evaluates what are the dimensions of individual items, the overall quantity of the purchased item, and the characteristics of the purchased items such as whether the items are perishable. For example, a consumer's shopping cart may hold an item for a day, and wait and evaluate if any of his/her friends are trying to buy something else. The seller may benefit from that as consumers who may identify an opportunity for a reduced shipping fee might be more likely to order. The invention can also send alerts to other users that there is a shipping opportunity available.

The invention compares the combined items' dimensions with the known dimensions of packing boxes. The invention calculates the shipping cost for the user if he purchases and ships his own items alone. The invention calculates the shipping cost based on items that can fit into the packaging box with more than one trusted party. The invention presents the user with a compared lists of reduced shipping cost along with suggested shipment sharing party's name/address. Thus, the user can decide whether he wants to ship his items with other people.

Although the embodiments herein have discussed shipment fom a seller to a buyer, the invention can optimize returns as well by tracking return requests from neighbors to combine the returns.

Further, to optimize packing and shipping costs even more, it is noted that a current order could be split up (or combined) with more than one neighbor's purchased item(s). Thus, a user's current order could be split up with two (or more) neighbors to further split costs between more people.

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 3, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

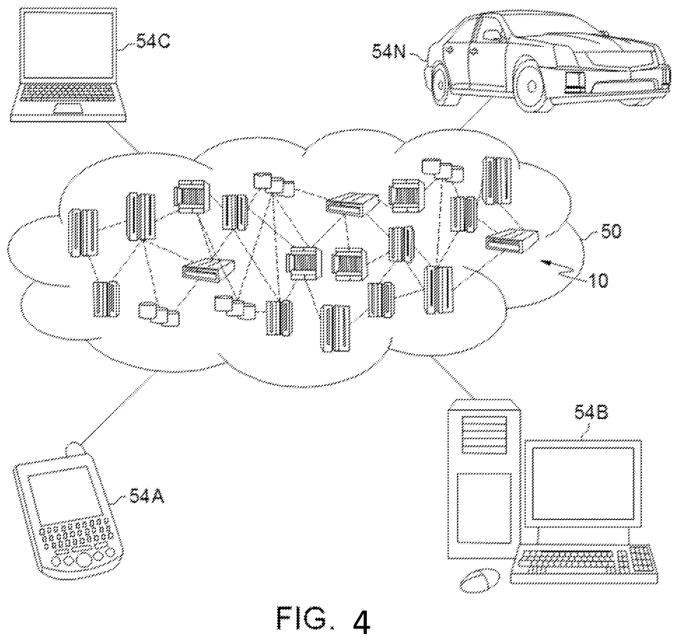

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below, Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and shipment sharing method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented shipment sharing method, the method comprising:
collecting a shopping order history, neighborhood information and friend information from user data;
analyzing a current order by a user from a shopping service;
checking whether a neighbor identified from the neighborhood information and the friend information purchased an item from the shopping service based on the shopping order history; and
suggesting to the user to share a packing and shipment cost with the neighbor by combining the purchased item by the neighbor and the current order by the user in a single package.

2. The method of claim 1, further comprising analyzing the purchased item from the neighbor and the current order by the user to determine an optimal combination of the purchased item and the current order into the single package.

3. The method of claim 1, further comprising sharing the packing and shipment cost between the user and the neighbor based on the user accepting the suggestion.

4. The method of claim 1, wherein a dimension, a quantity, and a characteristic of the purchased item and the current order are analyzed to determine an optimal packaging to combine orders into the single package.

5. The method of claim 4, wherein the packing and shipment cost is split between the user and the neighbor according to the dimension, the quantity and the characteristic of the purchased item and the current order.

6. The method of claim 1, further comprising creating a shipment plan for items in a subscription based on the neighbor and the user being subscribed to a subscription service.

7. The method of claim 1, embodied in a cloud-computing environment.

8. A computer program product for shipment sharing, the computer program product comprising a computer-readable storage medium having program instructions embodied therewith, the program instructions executable by a computer to cause the computer to perform:
collecting a shopping order history, neighborhood information and friend information from user data;
analyzing a current order by a user from a shopping service;
checking whether a neighbor identified from the neighborhood information and the friend information purchased an item from the shopping service based on the shopping order history; and
suggesting to the user to share a packing and shipment cost with the neighbor by combining the purchased item by the neighbor and the current order by the user in a single package.

9. The computer program product of claim 8, further comprising analyzing the purchased item from the neighbor and the current order by the user to determine an optimal combination of the purchased item and the current order into the single package.

10. The computer program product of claim 8, further comprising sharing the packing and shipment cost between the user and the neighbor based on the user accepting the suggestion.

11. The computer program product of claim 8, wherein a dimension, a quantity, and a characteristic of the purchased item and the current order are analyzed to determine an optimal packaging to combine orders into the single package.

12. The computer program product of claim 11, wherein the packing and shipment cost is split between the user and the neighbor according to the dimension, the quantity and the characteristic of the purchased item and the current order.

13. The computer program product of claim 8, further comprising creating a shipment plan for items in a subscription based on the neighbor and the user being subscribed to a subscription service.

14. A shipment sharing system, the system comprising:
a processor, and
a memory, the memory storing instructions to cause the processor to perform;
collecting a shopping order history, neighborhood information and friend information from user data;
analyzing a current order by a user from a shopping service;
checking whether a neighbor identified from the neighborhood information and the friend information purchased an item from the shopping service based on the shopping order history; and
suggesting to the user to share a packing and shipment cost with the neighbor by combining the purchased item by the neighbor and the current order by the user in a single package.

15. The system of claim 14, further comprising analyzing the purchased item from the neighbor and the current order by the user to determine an optimal combination of the purchased item and the current order into the single package.

16. The system of claim 14, further comprising sharing the packing and shipment cost between the user and the neighbor based on the user accepting the suggestion.

17. The system of claim 14, wherein a dimension, a quantity, and a characteristic of the purchased item and the current order are analyzed to determine an optimal packaging to combine orders into the single package.

18. The system of claim 17, wherein the packing and shipment cost is split between the user and the neighbor according to the dimension, the quantity and the characteristic of the purchased item and the current order.

19. The system of claim 14, further comprising creating a shipment plan for items in a subscription based on the neighbor and the user being subscribed to a subscription service.

20. The system of claim 14, embodied in a cloud-computing environment.
